(19) United States
(12) Patent Application Publication
(10) Pub. No.: US 2005/0157653 A1
(43) Pub. Date: Jul. 21, 2005

(54) Method and device for charging for uncounted network traffic overhead

(75) Inventors: Reuven Zeitak, Rehovot (IL); Uri Avigad, Kadima (IL)

Correspondence Address: DR. MARK FRIEDMAN LTD.;c/o Bill Polkinghorn, Discovery Dispatch, 9003 Florin Way, Upper Marlboro, MD, 20772, US

(73) Assignee: NATIVE NETWORKS TECHNOLOGIES LTD.

(21) Appl. No.: 10/828,333

(22) Filed: Apr. 21, 2004

Related U.S. Application Data
(60) Provisional application No. 60/536,737, filed on Jan. 16, 2004.

(51) Int. Cl. H04L 12/26

(52) U.S. Cl. 370/241

(57) ABSTRACT

A method for uncounted overhead charging calculates an overhead criterion, which defines the maximum difference in size between an output overhead and an input overhead of a data packet. Once the overhead criterion is determined, a rate regulator is configured to charge according to the value of the overhead criterion. The number of bytes designated in the overhead criterion is taken into account when policing the data traffic.

### CROSS REFERENCE TO RELATED APPLICATIONS

The present invention claims priority from U.S. Provisional Patent Application No. 60/536,737, filed 16 Jan. 2004.

### FIELD OF THE INVENTION

The present invention relates to data networks, and more particularly to methods for accounting for network traffic overhead.

### BACKGROUND OF THE INVENTION

Network traffic often travels over buses in the form of data packets or frames (both referred to hereafter as “packets”), each including a variable data payload that a source station sends to a destination station. Each packet also includes a header conveying data that the network devices need for the purpose of properly routing and processing the packet.

A network node (e.g., a switch, a router, a gateway, etc.) passes data packets received from a source station to a destination station based on the header information in the packet. The header portion, as shown in FIG. 1, includes a protocol overhead (POH) 120, and a client overhead (COH) 130. POH 120 may include a destination address, a source address, the length of the packet, a virtual local area network (VLAN) tag, a protocol identifier (TPID) field, and tag control information (TCI). COH 130 may include information on how to distribute the packet inside the client organization. A packet further includes payload data 140 to be transmitted, and may be further include data uses for error correction (e.g., CRC). The length of a packet can be tolerated between a maximum length and a minimum length as defined by the protocol type.

The Ethernet protocol clearly defines for Ethernet packets the beginning and the ending boundaries or “delimiters”. These are marked by special characters and by an inter-packet gap (IPG) overhead 110. IPG overhead 110 includes a fixed number of bytes that dictate the minimum space or “idle time” between the transmission of two consecutive packets. The size of IPG overhead 110 affects the available bandwidth, i.e., increasing the size of the IPG overhead 110 decreases the available bandwidth.

When the Ethernet traffic is transmitted over non-Ethemet networks such as synchronous digital hierarchy (SDH) networks or synchronous optical network (SONET) networks, the IPG overhead (e.g., IPG overhead 110) is removed from the Ethernet packets before being transmitted on the network. This is done by a device connected on a network access node called a “rate regulator”. The rate regulator is mainly used for policing data traffic (e.g., to control the bandwidth) and for transmitting packets to the network. After handling by the rate regulator, packets received on an egress port of a destination station are aggregated, and for each packet the IPG overhead is added. The number of extra bytes to be added to a packet is determined by the IPG demands of the Ethernet protocol. For example, the number of IPG bytes for 10 Mbps and 100 Mbps is 12 bytes and an additional 8 bytes of preamble overhead, to give a total of 20 overhead bytes. Adding the IPG overhead at the egress port, i.e. not counting the IPG overhead at the rate regulator, impacts the network performance and the committed quality of service (QoS).

Referring now to FIG. 2, which illustrates an example of one of the problems resulting from having uncounted IPG overhead at the rate regulator. FIG. 2 shows data packets 202-1, 202-2, and 202-3 transmitted from an ingress port 210 of an access node 200 to an egress port 230 of a destination station through a rate regulator 220. Ingress port 210 and rate regulator 220 are part of a network access node 200. In the example, ingress port 210 is a 100BaseT Ethernet port, capable of carrying packets at a rate of 100 Mbps, while egress port 230 is a 10BaseT Ethernet port, capable of carrying packets at a rate of 10 Mbps. Rate regulator 220 adjusts the rate of packets arriving from ingress port 210 to a rate complying with egress port 230. Rate regulator 220 receives the packets (e.g., packet 202-1) from ingress port 210 and forwards the packets (e.g., packet 202-2) through a communication link 280 to egress port 230. Packets are transmitted without the IPG and preamble overhead at a rate of 10 Mbps. Upon reception, egress port 230 adds for each packet (e.g., packet 202-3) an extra IPG and preamble overheads including a total of 20 bytes, as defined by the 10 Mbps Ethernet protocol standard. Hence, the size of each packet is increased by an additional 20 bytes. This results in excess bandwidth and congestion at egress port 230. In other words, the total bandwidth after adding the addition of the 20 bytes exceeds the bandwidth of the egress port. The impact of the unaccounted for IPG overhead increases the packet size decreases.

This problem can be resolved by configuration of rate regulator 220 to transmit packets at rate lower than the rate complying with egress port 230. The rate to transmit the packet can be calculated according to the following equation:
Rate=E-Rate*(packet size)/(packet size−[IPG+preamble overhead size]); (1)
where the E-rate is determined by the type of egress port 230 (e.g., 10 Mbps for 10BaseT). The packet size is the minimum length defined for a packet. Consequently, as a packet may be received in different sizes, pre-configuring rate regulator 220 to transmit packets at a rate designated by equation (1) may underutilize the bandwidth of egress port 230. For example, long packets will receive a rate lower than 10 Mbps.

We refer now to FIG. 3, which illustrates another example of one of the problems resulting from not counting the IPG overhead at the rate regulator. FIG. 3 shows two packets 302-1 and 302-2 transmitted respectively from an ingress port 310 in a network access node 300 and an ingress port 315 in a network access node 305 to a single egress port 330. Ingress ports 310 and 315 are connected to rate regulators 320 and 325 respectively, where each rate regulator transmits packets (e.g. packets 302-3 and 302-4) at a rate of 50 Mbps. In this example, ingress ports 310 and 315, as well as egress port 330 are all 100BaseT Ethernet ports. Egress port 330 aggregates the packets received from rate regulators 320 and 325. During aggregation, egress port 330 adds the IPG overhead for each incoming packet (e.g., packets 302-5 and 302-6). This may cause two kinds of difficulties in provisioning packets arriving at egress port 330. Egress port 330 cannot determine how to aggregate packets while not exceeding its rate. These difficulties may be answered by adjusting the bandwidths of the respective rate regulators 320 and 325. However, since the packets are transmitted at variable lengths this solution is not feasible.

A rate regulator may use several policing or shaping schemes to regulate the rate. These policing schemes may be three color marker, leaky bucket, adaptive leaky bucket, one bucket two colors, etc. The shaping schemes may be leaky bucket, dual leaky bucket and others. However, all of these policing and shaping schemes ignore the size of the IPG overhead when performing rate enforcement, and thus all the problems introduced above are not eliminated.

Therefore, it would be an advantageous to provide a solution that would efficiently resolve the limitations and shortcomings of the prior art.

### SUMMARY OF THE INVENTION

The present invention provides a method and device for charging for uncounted network traffic overhead. The invention allows service providers to charge users for uncounted overheads as part of the bandwidth users pay for. Alternatively, the invention provides the user with the actual bandwidth paid for inclusive of the overhead bytes. As a result, a node transmitting small packets and hence requiring relatively a high IPG overhead will either pay more for the bandwidth to account for the additional bandwidth it consumes, or otherwise be limited to the bandwidth actually paid for inclusive of the IPG overhead packets.

According to the present invention there is provided a method for charging for uncounted network traffic overhead, the traffic carried by data packets in a plurality of data paths, the method comprising the steps of: providing a rate regulator having a regulator bandwidth coupled to a respective ingress port, the rate regulator operative to regulate the rate of a data path established over a network between the respective ingress port and an egress port having an egress port bandwidth; determining a respective overhead criterion for the data path; and configuring the rate regulator with the respective overhead criterion to charge for uncounted overhead, whereby each data packet transmitted through the rate regulator is handled as a packet that has additional bytes as determined by the overhead criterion, thereby ensuring that the regulator bandwidth does not exceed the egress port bandwidth.

According to the present invention there is provided a network rate regulator having a regulator bandwidth and used for regulating data packet traffic carried on a data path established over a network between an ingress port and an egress port, the egress port having an egress bandwidth, the regulator comprising: a criterion determining mechanism for determining an overhead criterion for the data path; and a configuring mechanism for configuring the rate regulator with the overhead criterion to charge for uncounted overhead, whereby each data packet is handled as a packet that has additional bytes as determined by the overhead criterion, thereby ensuring that the regulator bandwidth of the rate regulator does not exceed the egress port bandwidth.

### BRIEF DESCRIPTION OF THE DRAWINGS

The invention is herein described, by way of example only, with reference to the accompanying drawings, wherein:

FIG. 1 is an exemplary diagram of a data packet;

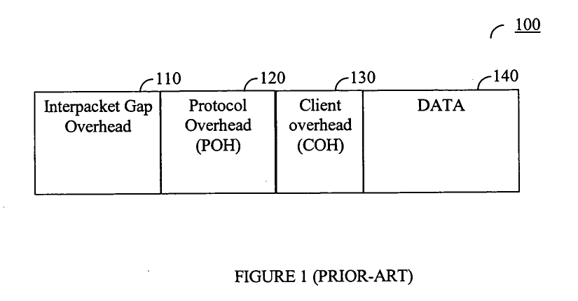

FIG. 2 is an exemplary diagram that demonstrates the problems involved with prior solutions;

FIG. 3 is another exemplary diagram that demonstrates the problems involved with prior solutions;

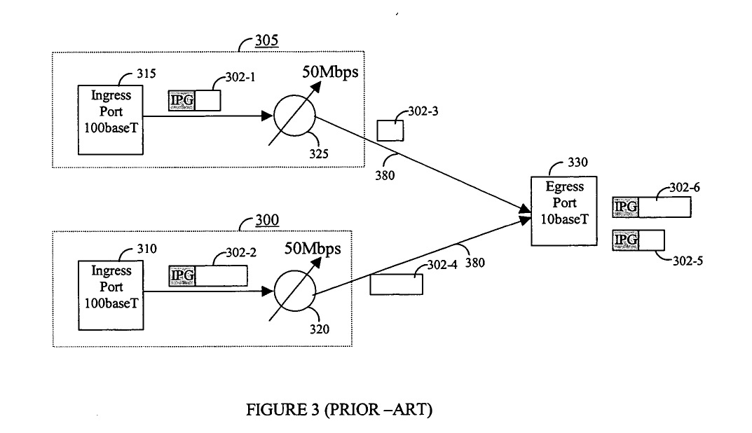

FIG. 4 is a non-limiting representation of a communications network system in which the present invention may be implemented;

FIG. 5 is an exemplary diagram showing data packets at various locations in a communications network system;

FIG. 6 is a non-limiting flowchart for the method for overhead charging according to the present invention.

### DETAILED DESCRIPTION OF THE PREFERRED EMBODIMENTS

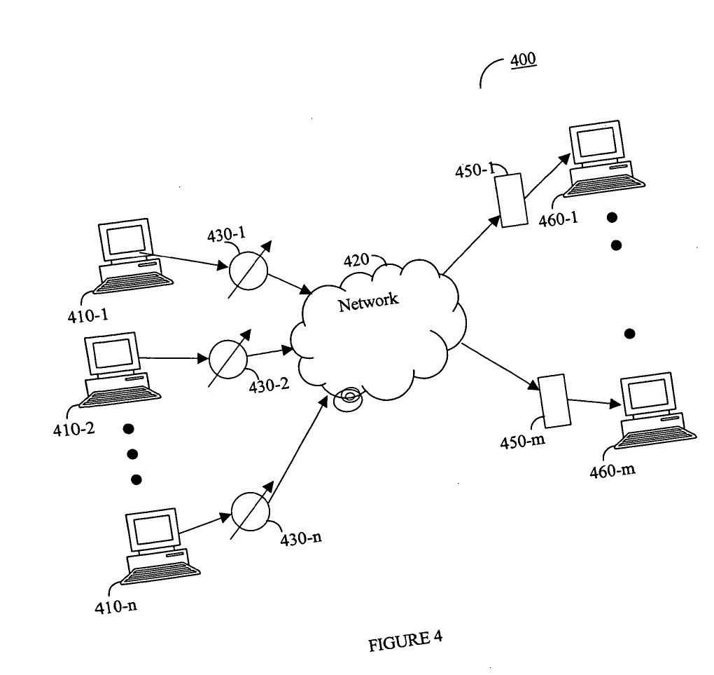

We refer now to FIG. 4, which illustrates a non-limiting representation of a communications network system 400 in which the present invention may be implemented. System 400 includes a network 420, which is the medium used to transmit Ethernet traffic and to provide communication links between various devices and computers connected together within system 400. Network 420 may be, but is not limited to, an Ethernet network, a metro Ethernet network (MEN), a local area network (LAN), or a virtual local area network (VLAN). The Ethernet traffic is transmitted over non-Ethernet networks, such as SDH/SONET networks. System 400 further includes ‘n’ packet sources 410-1 through 410-n, for example computer nodes, connected to network 420 through rate regulators 430-1 through 430-n respectively. Furthermore, ‘m’ destination nodes 460-1 through 460-m, for example computer nodes, are connected to network 420 through egress ports 450-1 through 450-m respectively. Rate regulators 430 communicate with source nodes 410 through ingress ports (not shown). Ingress ports and egress port may be, but are not limited to, 10 Mbps, 100 Mbps, and 1 Gbps Ethernet ports.

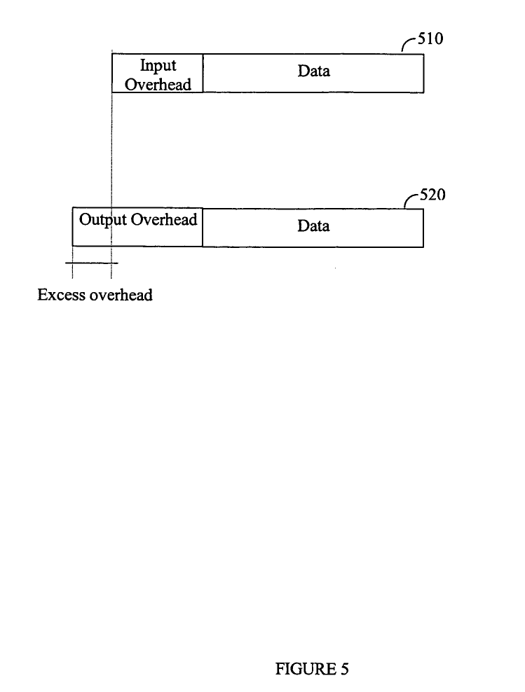

Packets transmitted from a source node 410 to a destination node 460 are limited by fixed bandwidth using a rate regulator 430, but the sizes of the overheads of the packets vary as the packets travel through system 400. FIG. 5 shows a packet 510 as an input packet at an input of the network after handling by a rate regulator, and packet 520 as an output packet of an egress port (e.g., an egress port 450 in FIG. 4). Each of packets 510 and 520 include a data portion and an overhead portion. The size of the data portion is fixed for packets 510 and 520, while the size of the overhead portion may vary from packet to packet. Furthermore, the packet size is greater when the packet is output (e.g., packet 520) then when it is input (e.g., packet 510), as the output overhead also includes, for example, the additional IPG bytes added by egress ports 450.

The present invention performs uncounted overhead charging at rate regulator 430 using an overhead criterion. The overhead criterion defines the maximum difference size between an output overhead of packet 520 and an input overhead of packet 510 traveling along the path established between an ingress port of a rate regulator (e.g., packet 430-1) and an egress port (e.g., packet 450-m). This difference is fixed for all packets and defined by the Ethernet protocol standard. For example, if the input overhead is 32 bytes and the output overhead is 52 bytes, the overhead criterion is equals to 52−32=20 bytes. The overhead criterion may be a function of some or all of these factors: the ingress port, the egress port, the rate regulated by the rate regulator, and the packet size. Once the overhead criterion is determined, the rate regulator is configured to charge according to the overhead criterion. That is, the number of bytes designated by the overhead criterion is taken into account as if they were part of the input overhead. This ensures that the bandwidth of rate regulator 430 does not exceed the bandwidth of egress port 450. An exemplary and non-limiting formula for calculating the overhead criterion is:
{IN_{S}−OUT_{S}}·Φ;
where IN_{S} is the size of an input packet at an input of the network, OUT_{S} is the size of an output packet of an egress port, and Φ is a rate factor. The rate factor Φ is equal to ‘1’ if the rate of the ingress port at a source node is higher than the rate of an egress port at a destination node. Otherwise, rate factor Φ is equal to ‘0’.

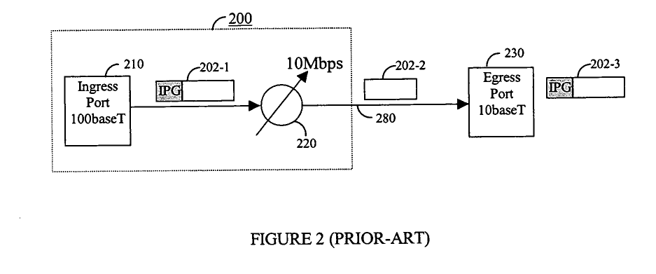

For illustration, refer back to the example discussed in FIG. 2 where the bandwidth of rate regulator 220 exceeds the bandwidth of egress port 230. The overhead criterion for the path established between ingress port 210 and egress port 230 is 20 bytes. The rate factor Φ is set to ‘1’ as ingress port 210 is 100BaseT and egress port 230 is 10BaseT. Rate regulator 220 is configured with the value of the overhead criterion, and as a result, rate regulator 220 treats each packet as if it has an additional 20 bytes. It is emphasized that the additional 20 bytes are not transmitted to egress port 230, but merely taken into account when policing or shaping the data traffic.

The inventors note that the disclosed method for overhead charging allows service providers to charge users for uncounted overheads as part of the bandwidth users pay for. Alternatively, the disclosed method provides the user with the actual bandwidth paid for inclusive of the overhead bytes. As a result, a node transmitting small packets and hence requiring a relatively high IPG overhead will either pay more for the bandwidth to account for the additional bandwidth consumed, or will otherwise be limited to the bandwidth actually paid for inclusive of the IPG overhead packets.

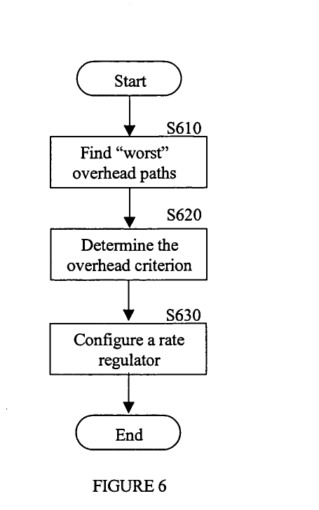

We refer now to FIG. 6, which shows a non-limiting flowchart 600 of the method for overhead charging according to the present invention. At step S610 the paths between ingress ports and egress ports are analyzed to determine if an overhead charging is required. From each ingress port, ‘m’ different paths can be established between ‘m’ different egress ports. The determination is based on types of the ingress and egress ports. For example, if an ingress port at a source node 410-n is 10BaseT and an egress port at a destination source 450-1 is 100BaseT then overhead charging is not required, since the packets transmitted to egress port 450-1 have a rate of 10 Mbps which is significantly lower than bandwidth of egress port 450-1 (i.e. 100 Mbps). Hence, the addition of the additional overhead does not exceed the bandwidth at egress port 450-1. On the other hand, if an ingress port at a source node 410-n is 100BaseT and an egress 450-m port is 100BaseT, then overhead charging is required. For this example, the path established between an ingress port at a source node 410-n and egress port 450-m is considered as a “worst” overhead path. At step S620, the overhead criterion is determined for each path detected as a candidate for overhead charging. At step S630, the rate regulator connected in the candidate path is configured with the value of the overhead criterion. Accordingly, the rate regulator handles each packet passing through as a packet that has additional bytes as designated by the overhead criterion.

The inventors note that the overhead charging method disclosed herein can be utilized by any policer or shaper known in the art. In particular, the overhead charging method can be executed by the policer disclosed in a co-pending U.S. patent application No. 60/535, 507 entitled “A Policer and Method for Resource Bundling” assigned to the common assignee and which is hereby incorporated by reference. We further note that the overhead criterion as disclosed herein may be used by any policing or shaping algorithms known in the art. In particular, the overhead criterion may be used in the shaping algorithms described in U.S. patent application Ser. No 09/572,194, filed Feb. 5, 2001, entitled “Multi-Level Scheduling Method for Multiplexing Packets in a Communications Network”, assigned to common assignee and incorporated herein by reference.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

While the invention has been described with respect to a limited number of embodiments, it will be appreciated that many variations, modifications and other applications of the invention may be made.

1. A method for charging for uncounted network traffic overhead, the traffic carried by data packets in a plurality of data paths, the method comprising the steps of:
a. providing a rate regulator having a regulator bandwidth and coupled to a respective ingress port, said rate regulator operative to regulate the rate of a data path established over a network between said respective ingress port and an egress port having an egress port bandwidth;
b. determining a respective overhead criterion for said data path; and,
c. configuring said rate regulator with said respective overhead criterion to charge for uncounted overhead, whereby each data packet transmitted through said rate regulator is handled as a packet that has additional bytes as determined by said overhead criterion, thereby ensuring that said regulator bandwidth does not exceed said egress port bandwidth.

2. The method of claim 1, wherein said step of providing a rate regulator coupled to a respective ingress port includes providing a rate regulator coupled to an ingress port having a rate selected from the group consisting of 10 Mbps, 100 Mbps and 1 Gbps.

3. The method of claim 2, wherein said ingress port is an Ethernet port.

4. The method of claim 1, wherein said step of determining a respective overhead criterion for said data path includes determining an overhead criterion that defines the maximum difference size between an output overhead and an input overhead of each said data packet.

5. The method of claim 4, wherein said determining an overhead criterion includes calculating said overhead criterion using the formula {IN_{S}−OUT_{S}}·Φ, wherein IN_{S} is the size of an input packet input at said respective ingress port, OUT_{S} is the size of an output packet output at said respective egress port, and Φ is a rate factor.

6. The method of claim 5, wherein said rate factor Φ is equal to 1 if a rate of a ingress port at a source node is higher than a rate of said egress port, and wherein said rate factor Φ is equal to 0 if a rate of said ingress port is lower than said rate of said egress port.

7. The method of claim 1, wherein step of providing a rate regulator operative to regulate the rate of a data path established over a network includes providing an Ethernet based network having Ethernet traffic.

8. The method of claim 7, wherein said Ethernet based network is selected from the group consisting of a metro Ethernet network (MEN), a local area network (LAN), and a virtual local area network (VLAN).

9. The method of claim 7, wherein said Ethernet traffic is transmitted over a non-Ethernet network.

10. The method of claim 9, wherein said non-Ethernet network is selected from the group consisting of a SDH network and a SONET network.

11. The method of claim 1, wherein said egress port is an Ethernet port selected from the group consisting of 10 Mbps, 100 Mbps and 1 Gbps.

12. A network rate regulator having a regulator bandwidth and used for regulating data packet traffic carried on a data path established between an ingress port and an egress port, said egress port having an egress port bandwidth, the regulator comprising:
a. a criterion determining mechanism for determining an overhead criterion for said data path; and
b. a configuring mechanism for configuring the rate regulator with said overhead criterion to charge for uncounted overhead, whereby each data packet is handled as a packet that has additional bytes as determined by said overhead criterion, thereby ensuring that said regulator bandwidth does not exceed said egress port bandwidth.

13. The rate regulator of claim 12, wherein each said data packet has an input overhead and an output overhead, and wherein said overhead criterion is defined as a maximum difference between said output overhead and said input overhead.

14. The rate regulator of claim 13, wherein said overhead is calculated using the formula {IN_{S}−OUT_{S}}·Φ, wherein IN_{S} is the size of an input packet input at said respective ingress port, OUT_{S} is the size of an output packet output at said respective egress port and Φ is a rate factor.

15. The rate regulator of claim 14, wherein said rate factor Φ is equal to 1 if a rate of a ingress port at a source node is higher than a rate of said egress port, and wherein said rate factor Φ is equal to 0 if a rate of said ingress port is lower than said rate of said egress port,

16. The rate regulator of claim 12, wherein said network is an Ethernet based network having Ethernet traffic.

17. The rate regulator of claim 16, wherein said Ethernet based network is selected from the group consisting of a metro Ethernet network (MEN), a local area network (LAN), or a virtual local area network (VLAN).

18. The rate regulator of claim 16, wherein said Ethernet traffic is transmitted over non-Ethernet networks.

19. The rate regulator of claim 18, wherein said non-Ethemet network is selected from the group consisting of a SDH network and a SONET network.

20. The rate regulator of claim 12, wherein said egress port is an Ethernet port selected from the group consisting of 10 Mbps, 100 Mbps and 1 Gbps.

21. The rate regulator of claim 12, wherein said ingress port is an Ethernet port selected from the group consisting of 10 Mbps, 100 Mbps and 1 Gbps.
